(19) United States
(12) Patent Application Publication
(10) Pub. No.: US 2022/0308937 A1
(43) Pub. Date: Sep. 29, 2022

(54) COMPUTER AND JOB SCHEDULING METHOD

(71) Applicant: FUJITSU LIMITED, Kawasaki-shi (JP)

(72) Inventors: Shingo OKUNO, Kawasaki (JP); Masahiro MIWA, Kawaguchi (JP)

(73) Assignee: FUJITSU LIMITED, Kawasaki-shi (JP)

(21) Appl. No.: 17/646,932

(22) Filed: Jan. 4, 2022

(30) Foreign Application Priority Data
Mar. 16, 2021 (JP) 2021-042968

(51) Int. Cl. G06F 9/50

(52) U.S. Cl. CPC G06F 9/5088; G06F 9/5016; G06F 9/5027

(57) ABSTRACT

A processor acquires and stores a new-job, acquires information regarding an execution state of existing-jobs run on the compute nodes for each group of compute nodes that have a short communication distance, when the new-job is deployed in the compute nodes that belong to the group, based on the acquired information regarding the execution state, obtains, for each group, a probability in which the existing-jobs or a part of the new-job is deployed in the compute nodes that belong to a group different from a deployment destination group in which the new-job is deployed, determines a group in which the new-job is deployed, based on the obtained probability and a usage amount of the compute nodes for each group by the existing-jobs, and acquires the stored new-job, and deploy the new-job in the compute node, based on the determination of the group in which the new-job is to be deployed.

### CROSS-REFERENCE TO RELATED APPLICATION

This application is based upon and claims the benefit of priority of the prior Japanese Patent Application No. 2021-42968, filed on Mar. 16, 2021, the entire contents of which are incorporated herein by reference.

### FIELD

The embodiments discussed herein are related to a computer and a job scheduling method.

### BACKGROUND

Neural network learning has been greatly advanced due to a strong and efficient parallel processing capability of a graphics processing unit (GPU). Moreover, in order to handle a larger learning model using more learning parameters, a GPU cluster including compute nodes, each of which has a plurality of GPUs, is generally used. Here, the compute node is a device that executes a job and generally indicates a server or the like. The GPU cluster executes a plurality of jobs in parallel, and the plurality of jobs shares the same compute node in many cases. A state where the plurality of jobs shares the same compute node may be referred to as co-located. For example, among large GPU clusters, there is a system that includes 1000 or more compute nodes each of which mounts four or eight GPUs and includes a shared file system, a cloud storage, an InfiniBand network that couples these, or the like.

Most of a workflow when the neural network is learned by each compute node of such a GPU cluster is offload-executed calculated by the GPU. In other words, for example, it can be said that most of resources consumed in the learning of the neural network are in the GPU side.

A processing flow for learning a neural network is as follows. First, initialization is performed, and a data library is loaded. Next, a gradient is calculated by a GPU. Next, a learning model is updated, based on the calculated gradient. Then, until an evaluation index exceeds a target value or an execution elapsed time reaches an upper limit, the calculation of the gradient and the update of the learning model are repeated.

In recent years, the size of a leaning task has been increased due to complexity of the learning model or the like, and the number of cases where distributed training using the plurality of GPUs (compute nodes) is performed has been increased. In a case where one process is allocated to each GPU and distributed training is performed, the processes (compute nodes) may communicate among them for reasons such as gradient sharing. Here, a case will be described where distributed training is performed by synchronous data parallelism. For example, forward calculation and backward calculation are performed by a GPU mounted on a specific compute node using specific data, and a GPU mounted on another compute node performs forward calculation and backward calculation using another piece of data. Then, the GPU of each compute node shares calculation results with each other and updates the learning model. However, at this time, communication occurs after the processes are synchronized.

In such distributed training, there is a case where auto-scaling such as scale-in or scale-out of a process is performed after job execution is started. The scale-in is a technique that excludes some processes from among a plurality of processes for executing jobs. Furthermore, the scale-out is a technique that adds a new process to processes for executing jobs. In order to efficiently and accurately perform the neural network, the auto-scaling techniques have been actively studied also in the academic world.

For example, as an application example of scale-in, a method called straggler mitigation exists. The straggler mitigation is a method for excluding a process executed by a GPU from a job in a case where a straggler occurs in a GPU of which processing delays than other GPUs. Straggler occurs for various reasons such as a high temperature of a GPU or a shared job. In a case where a straggler occurs in a job, a waiting time before synchronization increases due to the straggler. However, by excluding the straggler process executed by the GPU from the job, the waiting time can be shortened.

On the other hand, scale-out is performed so as to shorten a time required for learning the neural network by increasing the processes for executing the job in a case where learning of the neural network takes more time than expected or the like. In addition, scale-out is performed also in a case where the straggler recovers from slowdown and the process executed by the GPU returns to the job after the straggler is excluded by scale-in.

Here, in a case where distributed training is performed, a job is arranged in a compute node at the time start of job execution, scale-in, and scale-out. As this technique for arranging the job in the compute node, there is a technique for waiting for job execution until an ideal compute node group becomes available. Furthermore, there is a technique for dynamically migrating a process being executed by a remote node according to operation characteristics.

In addition, there is a technique for determining a compute node where a job is assigned, based on communication characteristics of the job and communication characteristics of interconnect between the compute nodes. Moreover, as a technique regarding auto-scale, there is a technique for moving data, including one held by a server previous to a server to be added, to the server to be added among the data of jobs that are continuously executed by each server, at the time of adding the server.

Japanese Laid-open Patent Publication No. 2016-099972, Japanese Laid-open Patent Publication No. 2011-175573, and Japanese Laid-open Patent Publication No. 2012-038053 are disclosed as related art.

### SUMMARY

According to an aspect of the embodiments, a computer including a plurality of compute nodes that executes a job and is communicable with each other, the computer includes a memory, and a processor coupled to the memory and configured to acquire a new job and store the new job in the memory, acquire information regarding an execution state of existing jobs run on the compute nodes for each group of the compute nodes that have a short communication distance, when the new job is deployed in the compute nodes that belong to the group, based on the acquired information regarding the execution state, obtain, for each group, a probability in which the existing jobs or a part of the new job is deployed in the compute nodes that belong to a group different from a deployment destination group in which the new job is deployed, determine a group in which the new job is deployed, based on the obtained probability and a usage amount of the compute nodes for each group by the existing jobs, and acquire the stored new job, and deploy the new job in the compute nodes, based on the determination of the group in which the new job is to be deployed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram illustrating an example of a cluster system;

FIG. 2 is a hardware configuration diagram of a compute node;

FIG. 3 is a block diagram regarding a job deployment function of the cluster system;

FIG. 4 is a diagram for explaining auto-scale processing;

FIG. 5 is a diagram for explaining a method for calculating a rack empty state;

FIG. 6 is a diagram illustrating an example of new job deployment;

FIG. 7 is a diagram illustrating an outline of processing for determining a deployment destination compute node;

FIG. 8 is a flowchart of job deployment processing by a cluster system according to a first embodiment; and

FIG. 9 is a diagram for explaining free space calculation according to a second embodiment.

### DESCRIPTION OF EMBODIMENTS

When a job is assigned to a compute node, there is a case where some processes of the job are assigned to compute nodes that are in a remote positional relationship. For example, in a case where a compute node assigned near a compute node on which a process of a specific job executes is occupied by another job, it is difficult to collectively assign all the processes of the specific job to an adjacent node. In that case, the number of hops for connecting between the compute nodes increases, and there is a possibility that communication cost increases. Furthermore, in a case where communication is performed via a plurality of switches, collision with communication of another job occurs. This causes the performance degradation due to the increased load on the switch, and there is a possibility that the communication cost further increases.

Therefore, it is considered to realize ideal assignment using a technique for waiting for job execution until an ideal compute node group becomes available. However, because unnecessary waiting time occurs and this delays entire processing, this technique is not realistic. Furthermore, with the technique for dynamically migrating a process being executed in a remote node according to operation characteristics, the cost of migration is high. Therefore, it is difficult to obtain an effect of reducing communication cost. Furthermore, with the technique for determining the compute node where the job is assigned, based on the communication characteristics of the job and the communication characteristics of the interconnect between the compute nodes, a communication path between the compute nodes is not considered, and it is difficult to reduce the communication cost. Moreover, with the technique for moving the data including one held by the previous server to the server to be added among the data of the jobs continuously executed, an effect is considered for equalizing loads and reducing the number of communications. However, there is a possibility that a communication path is lengthened, and it is difficult to reduce the communication cost.

Hereinafter, embodiments of the technology for reducing communication cost will be described in detail with reference to the drawings. Note that a computer and a job scheduling method disclosed in the present application are not limited to the following embodiments.

### First Embodiment

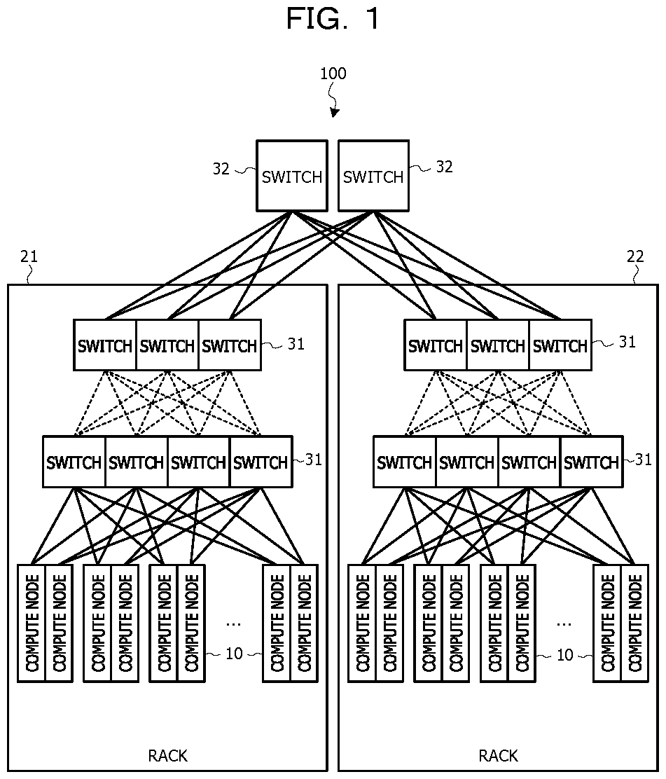

FIG. 1 is a configuration diagram illustrating an example of a cluster system. As illustrated in FIG. 1, a cluster system 100 according to the present embodiment is a computer including racks 21 and 22. Here, in FIG. 1, the two racks 21 and 22 are illustrated. However, the number of racks included in the cluster system 100 may be equal to or more than three and is not particularly limited. Hereinafter, in a case where each rack including the racks 21 and 22 included in the cluster system 100 is not distinguished, the racks are referred to as a “rack 20”.

Each of the racks 21 and 22 mounts a plurality of compute nodes 10. Furthermore, switches 31 respectively connected at multiple stages are arranged in the racks 21 and 22. The compute nodes 10 mounted on the rack 21 can communicate with each other using the switches 31 arranged in the rack 21. Similarly, the compute nodes 10 mounted on the rack 22 can communicate with each other using the switches 31 arranged in the rack 22.

Moreover, a network in the rack 21 and a network in the rack 22 are connected with switches 32 that connect the racks 21 and 22. Then, the compute node 10 arranged in the rack 21 and the compute node 10 arranged in the rack 22 can communicate with each other via the switch 32 that connects the racks 21 and 22. Here, even in a case where the cluster system 100 includes three or more racks 20, the switches 32 for connecting the racks 20 are arranged, and the compute node 10 arranged in each rack 20 can communicate to a compute node 10 arranged in any rack 20.

In a case of the configuration illustrated in FIG. 1, the five switches 31 and 32 relay transmission of a signal from the compute node 10 arranged in the rack 21 to the compute node 10 arranged in the rack 22. In other words, for example, the number of hops between the compute node 10 arranged in the rack 21 and the compute node 10 arranged in the rack 22 is six. Here, as the number of hops between the compute nodes 10 for communicating with each other increases, the communication cost increases. In other words, for example, the cost of communication within the rack 21 or 22 can be suppressed to be lower than that of the communication between the racks 21 and 22.

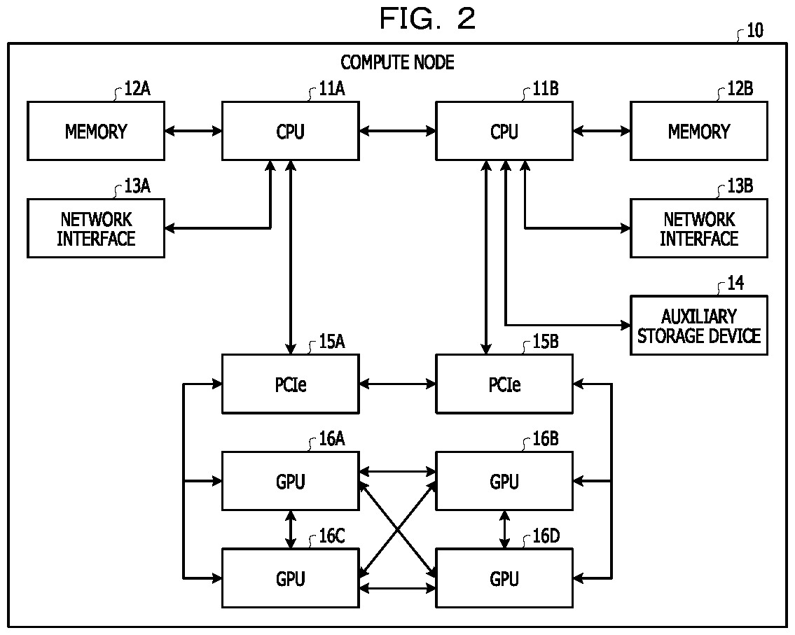

FIG. 2 is a hardware configuration diagram of a compute node. As illustrated in FIG. 2, the compute node 10 includes central processing units (CPU) 11A and 11B, memories 12A and 12B, network interfaces 13A and 13B, an auxiliary storage device 14, peripheral component interconnect expresses (PCIe) 15A and 15B, and GPUs 16A to 16D.

The CPUs 11A and 11B are connected to be communicable with each other. Furthermore, the CPU 11A is connected to the memory 12A, the network interface 13A, and the PCIe 15A. The CPU 11A communicates with each of the GPUs 16A to 16D via the PCIe 15A. Furthermore, the CPU 11B is connected to the memory 12B, the network interface 13B, the auxiliary storage device 14, and the PCIe 15B. The CPU 11B communicates with each of the GPUs 16A to 16D via the PCIe 15B. The CPUs 11A and 11B control and manage operations of each unit of the compute node 10. Furthermore, the CPUs 11A and 11B manage communication with another compute node 10.

The memories 12A and 12B are primary storage devices. For the memories 12A and 12B, for example, a double data rate (DDR) 4 synchronous dynamic random-access memory (SDRAM) can be used.

The network interfaces 13A and 13B are, for example, InfiniBand host bus adapters (HBA). The network interfaces 13A and 13B are connected to an external switch 31 (refer to FIG. 1) and relay the communication with another compute node 10.

The auxiliary storage device 14 is, for example, a non-volatile storage medium connected using the non-volatile memory express (NVMe).

The GPUs 16A to 16D are connected to be communicable with each other. The GPUs 16A to 16D receive an input of a job from the CPU 11A or 11B and execute the input job. The GPUs 16A to 16D execute, for example, a job for training a neural network. The GPUs 16A to 16D read data and a library and calculate a gradient using a learning model. Then, the GPUs 16A to 16D update the learning model using the calculated gradient. The GPUs 16A to 16D train the learning model by repeating to calculate the gradient and update the learning model. In the present embodiment, the GPUs 16A to 16D perform distributed training. Therefore, when the learning model is updated, for example, the GPU 16A communicates with GPUs 16B to 16D on a compute node 10, mounting the GPU 16A, that performs distributed training in cooperation or GPUs 16A to 16D mounted on another compute node 10 and shares the gradients or the like.

Here, as described above, as the number of hops between the compute nodes 10 for communicating with each other increases, the communication cost increases. Therefore, the cluster system 100 according to the present embodiment arranges jobs so as to reduce the number of hops in the communication occurred by the execution of the job.

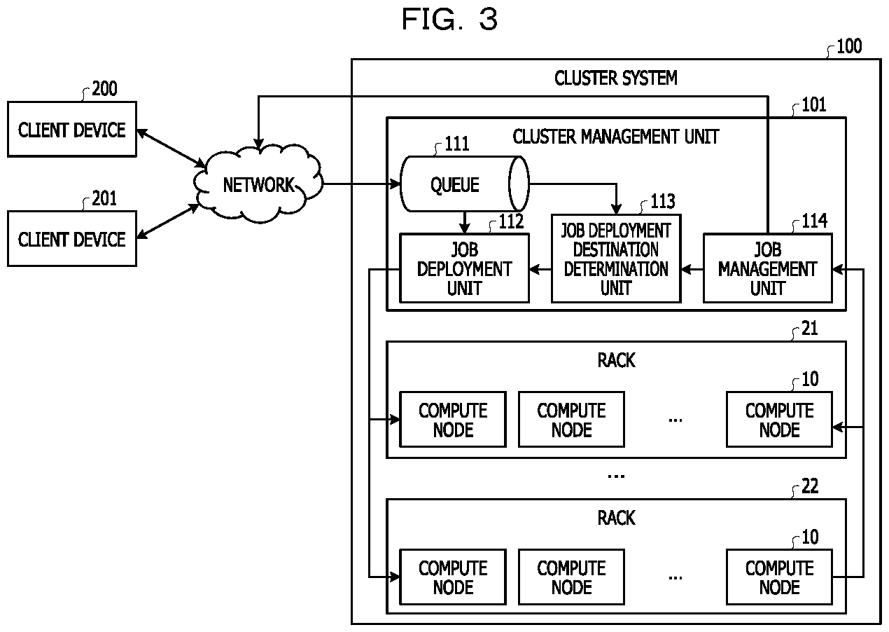

FIG. 3 is a block diagram regarding a job deployment function of a cluster system. Job deployment by a cluster system 100 according to the present embodiment will be described below with reference to FIG. 3.

The cluster system 100 is connected to an external device such as client devices 200 and 201 via a network. The client devices 200 and 201 are terminal devices operated by a user who requests the cluster system 100 to execute a job to train a neural network. Here, in FIG. 3, as an example, the two client devices 200 and 201 are illustrated. However, in many cases, a large number of terminal devices actually exist.

For example, the user requests job deployment to the cluster system 100 using the client device 200. At this time, the client device 200 transmits information used to designate a job to be executed and data used to execute the job to the cluster system 100.

The cluster system 100 holds a large number of racks 20 including the racks 21 and 22. Each rack 20 mounts a plurality of compute nodes 10. As illustrated in FIG. 1, the compute nodes 10 are connected to be individually communicable with each other using the plurality of switches 31 and 32.

Moreover, the cluster system 100 includes a cluster management unit 101. The cluster management unit 101 determines a compute node 10 to be a job arrangement destination and deploys the job to the assigned compute nodes 10. In order to implement functions of the cluster management unit 101, one compute node 10 may be allocated, or a part of resources of the compute node 10 that executes the job may be used. The cluster management unit 101 includes a queue 111, a job deployment unit 112, a job deployment destination determination unit 113, and a job management unit 114.

A new job designated in response to an execution request from the client device 200 is input to the queue 111, and the queue 111 stores the input job. For example, multiple jobs are arranged in order in the queue 111.

The job management unit 114 confirms an existing job being executed in the cluster system 100. Specifically, for example, the job management unit 114 transmits a management command to each compute node 10 and acquires information regarding a job execution status. Then, the job management unit 114 transmits, via a network, each execution status of each job to, for example, the client device 200 or 201 that has requested to execute each existing job that is being executed. Furthermore, the job management unit 114 outputs the execution status of each job to the job deployment destination determination unit 113. This job execution status includes information used to acquire the execution state of the existing job such as information representing a resource amount in use for each rack 20 or information representing a possibility of a fluctuation in the resource amount in use.

Furthermore, the job management unit 114 monitors collective communication performed in the existing job. Then, the job management unit 114 determines to execute scale-out or scale-in of each job according to the number of processes participating in communication. Then, the job management unit 114 notifies the job deployment destination determination unit 113 of an instruction to execute scale-in or scale-out of the job on the basis of the determination.

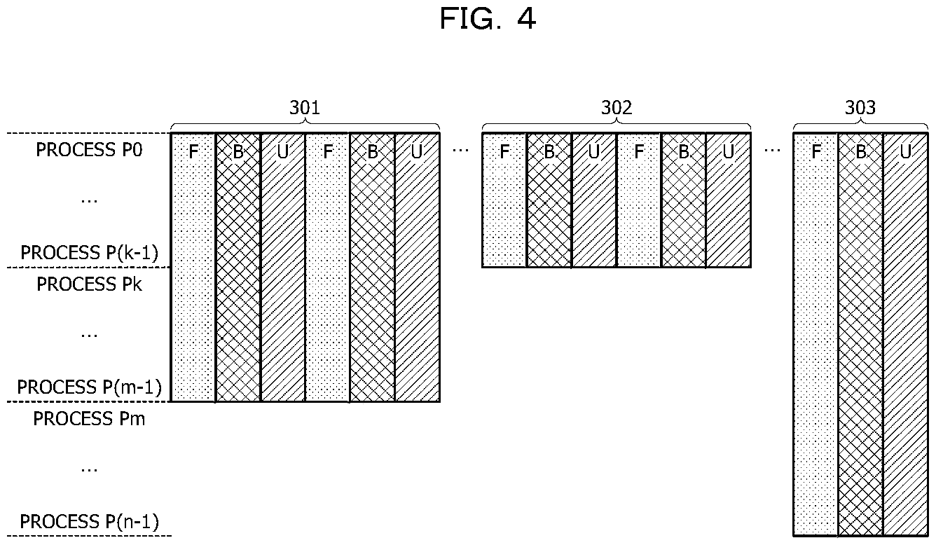

FIG. 4 is a diagram for explaining auto-scale processing. In FIG. 4, the vertical axis indicates a type of a process that executes processing, and the horizontal axis indicates a type of processing to be executed with time. Here, a case will be described where n processes P0 to P (n−1) exist as processes of a job. As the types of the processing to be executed, F represents forward processing, B represents backward processing, and U represents learning model update processing referred to as update. In this case, communication between processes is performed in the update processing.

For example, the job management unit 114 monitors collective communication in a period 301 and confirms that the processes P0 to P (m−1) participate in the collective communication. Then, in a case where it is determined that the number of processes participating in the execution of the job is large with respect to a load of the job to be executed, the job management unit 114 determines to perform scale-in on the job. As a result, the processes participating in the execution of the job are reduced to processes P0 to P (k−1).

Next, the job management unit 114 monitors collective communication in a period 302 and confirms that the processes P0 to P (k−1) participate in the collective communication here. Then, in a case where it is determined that the number of processes participating in the execution of the job is small with respect to the load of the job to be executed, the job management unit 114 determines to perform scale-out on the job. As a result, the processes participating in the execution of the job are increased to processes P0 to P (n−1) and execute the job as indicated in a period 303.

The job deployment destination determination unit 113 receives an input of the execution status of each job from the job management unit 114. Next, the job deployment destination determination unit 113 calculates a score indicating a probability that some processes of a job to be input are deployed in another rack 20 with respect to the rack 20 to be a deployment destination candidate using the information, regarding the execution state of each job being executed, acquired from the execution status.

For example, the job deployment destination determination unit 113 calculates the score using the following formula (1).

s=k₀x₀+k₁x₁+k₂x₂ (1)

Here, ki is a coefficient with respect to an element xi and is a value preset according to how much the element xi is emphasized. The larger ki is, the more important the element xi is. Furthermore, the xi is information representing a job execution state. The information representing the job execution state is information used to obtain an amount of resources in use for each rack 20, information representing a possibility of a fluctuation in the amount of the resources in use, or the like.

More specifically, for example, as xi, information representing a job processing load or a free space can be used. For example, as xi, the number of executions of the process in each rack 20 can be used. Furthermore, as xi, the number of processes that is reduced by scale-in can be used. From this information, it can be determined that there is a high possibility of scale-out performed in order to return the reduced processes. Furthermore, as xi, a remaining time to an upper limit value of a job execution time can be used. From this information, it can be determined that there is a high possibility that the number of processes is increased in a case of immediately after job start, and it can be determined that there is a high possibility that the number of processes is decreased in a case where the job is close to end. Furthermore, as xi, characteristics of a user or characteristics of a process obtained from operation information in the past can be used. For example, it can be determined that there is a high possibility that the same user executes the same binary a plurality of times for hyperparameter tuning or the like. Furthermore, a probability that the number of processes fluctuates can be obtained, based on the past results.

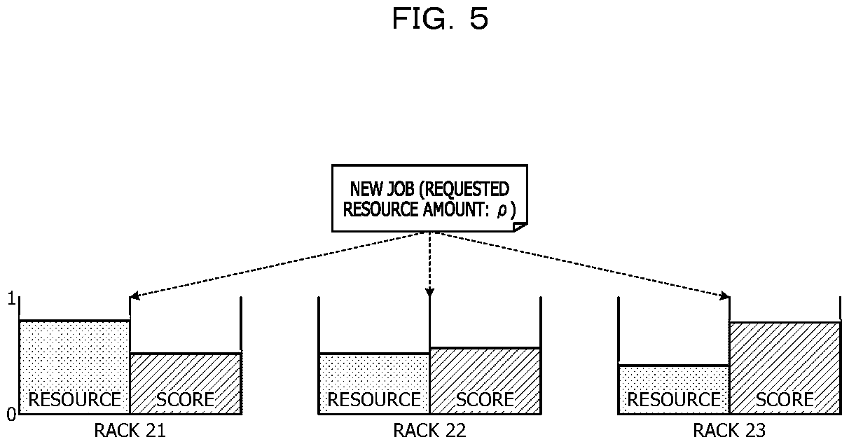

FIG. 5 is a diagram for explaining a method for calculating a rack empty state. Here, a case will be described where racks 21 to 23 exist. In FIG. 5, the entire resources of the respective racks 21 to 23 are the same, and all the resources are normalized to one. A left-side part of each of the racks 21 to 23 as facing the paper surface indicates an actual resource, and a right-side part as facing the paper surface indicates a state according to a probability that the existing job or a new job to be input is deployed in the compute node 10 of another rack 20. Furthermore, here, a job of which a requested resource amount is p is inserted as a new job. The requested resource amount is a value indicating how many compute nodes 10 are required by the job as resources to be used.

The score calculated for each of the racks 21 to 23 by the job deployment destination determination unit 113 is represented by a right-side portion of each of the racks 21 to 23 on a paper surface in FIG. 5. The score is an index indicating a probability that a part of processes included in an existing job or a new job to be deployed is deployed in another rack 20. In other words, for example, it can be said that the rack 20 having the higher score has a higher possibility that a part of the job deployed in the rack 20 is deployed in another rack 20.

Next, the job deployment destination determination unit 113 obtains a resource amount in use in each rack 20 from the job execution status. For example, the resource amount in use obtained by the job deployment destination determination unit 113 is represented by a left-side portion of each of the racks 21 to 23 on the paper surface in FIG. 5.

Moreover, the job deployment destination determination unit 113 acquires the information of the new job designated by the execution request from the client device 200 from the queue 111 and acquires a requested resource amount that is a resource amount used to deploy the new job. Then, for the determination regarding the rack 20 where the new job is deployed, the job deployment destination determination unit 113 uses a bin packing problem for packing the new job in any one of the racks 20 using the calculated score, the resource amount in use of each rack 20, and the requested resource amount. By solving this bin packing problem, the job deployment destination determination unit 113 determines the rack 20 in which the designated job is deployed.

In the present embodiment, the job deployment destination determination unit 113 solves the bin packing problem using a Best-Fit method that is a method for loading an item in a box with the smallest free space among boxes in which items may be loaded, as an algorithm for solving the bin packing problem. For example, the job deployment destination determination unit 113 calculates fi that is an arrangement possibility index of each rack 20 using the following formula (2).

$${f}_{i} = 1 - ( {r}_{i} + ρ ) + λ {s}_{i} \qquad ( 2 )$$

$${r}_{i} + ρ \leq 1$$

Here, i is a number sequentially allocated to each rack 20 from one. Hereinafter, an i-th rack 20 is referred to as a rack i. The reference ri indicates a resource amount used by the rack i. Furthermore, the reference ρ indicates a requested resource amount of a newly deployed job. Furthermore, the reference λ indicates a coefficient for giving a score importance. Furthermore, the reference si indicates a score of the rack i.

The job deployment destination determination unit 113 determines that the rack i having a smaller value fi is a preferable rack 20 as a deployment destination of the new job. In other words, for example, the job deployment destination determination unit 113 selects the rack 20 where the job is deployed in consideration of that the rack 20 can use the resource amount up to the upper limit as possible and the rack 20 has a low probability that some jobs are deployed in another rack 20. However, in a case where the total of the resource amount in use and the requested resource amount of the job to be deployed exceeds the resource amount of the entire rack 20, the job deployment destination determination unit 113 does not deploy the job in the rack 20.

Then, the job deployment destination determination unit 113 determines the rack 20 with the smallest fi as the rack 20 in which the new job is deployed, using the calculated score and the resource amount in use in each rack 20. Thereafter, the job deployment destination determination unit 113 notifies the job deployment unit 112 of information regarding the compute nodes 10 in the rack 20 that execute the new job to be deployed.

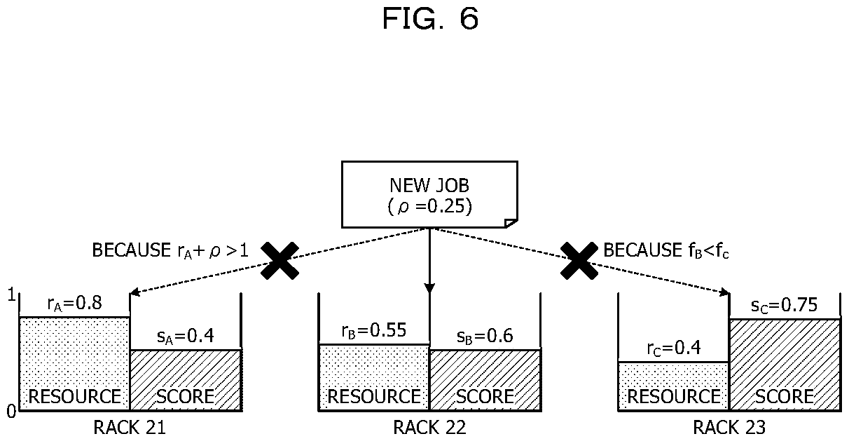

FIG. 6 is a diagram illustrating an example of new job deployment. An example of the new job deployment will be described with reference to FIG. 6. Here, a case will be described where a requested resource amount of a new job is 0.25 and a coefficient representing a score importance is one. For example, the job deployment destination determination unit 113 calculates that the score is 0.4 with a resource amount in use in the rack 21 of 0.8, the score is 0.6 with a resource amount in use in the rack 22 of 0.55, and the score is 0.75 with a resource amount in use in the rack 23 of 0.4. In FIG. 6, r_{A} and s_{A} respectively represent the resource amount in use in the rack 21 and the score, r_{B} and s_{B} respectively represent the resource amount in use in the rack 22 and the score, and r_{C} and s_{C} respectively represent the resource amount in use in the rack 23 and the score.

In this case, the job deployment destination determination unit 113 determines that it is not possible to deploy the new job in the rack 21 because the sum of the resource amount in use in the rack 21 and the requested resource amount of the new job exceeds the resource amount of the entire rack 21. Then, because an arrangement possibility index of the rack 22 is smaller than an arrangement possibility index of the rack 23, the job deployment destination determination unit 113 determines to deploy the new job in the rack 22.

Furthermore, the job deployment destination determination unit 113 receives a scale-in execution instruction from the job management unit 114. Then, the job deployment destination determination unit 113 determines a compute node 10 to be a scale-in target from among the compute nodes 10 executing the process of the job that performs scale-in. In particular, in a case where the jobs to be the scale-in targets operate in the compute nodes 10 in the different racks 20, the job deployment destination determination unit 113 determines the compute node 10 to be the scale-in target so that all the processes of the job are executed by the compute nodes 10 in the single rack 20. Then, the job deployment destination determination unit 113 notifies the job deployment unit 112 of information regarding the compute node 10 determined to be the scale-in target.

Furthermore, the job deployment destination determination unit 113 receives a scale-out execution instruction from the job management unit 114. Then, the job deployment destination determination unit 113 determines which compute nodes 10 will be assigned for a job to be a scale-out target. In a case where the compute nodes 10 mounted on the rack 20 in which the job to be the scale-out target operates are not sufficient, the job deployment destination determination unit 113 assigns a compute node 10 of another rack 20 as a scale-out target. Then, the job deployment destination determination unit 113 notifies the job deployment unit 112 information regarding the compute node 10 determined as the scale-out target.

The job deployment unit 112 acquires a new job designated by the execution request from the client device 200 from the queue 111. Moreover, the job deployment unit 112 receives a notification of a compute node 10, which is a job deployment destination, mounted on the rack 20 that is determined as the job deployment destination from the job deployment destination determination unit 113. Then, the job deployment unit 112 deploys the new job acquired from the queue 111 in the compute node 10 designated as the deployment destination.

Furthermore, the job deployment unit 112 receives a notification of the compute node 10 to be the scale-in target from the job deployment destination determination unit 113. Then, the job deployment unit 112 stops the process of the job that operates on the compute node 10 designated as the scale-in target.

Furthermore, the job deployment unit 112 receives a notification of the compute node 10 to be the scale-out target from the job deployment destination determination unit 113. Then, the job deployment unit 112 makes the compute node 10 designated as the scale-out target start to execute the process of the scale-out target job.

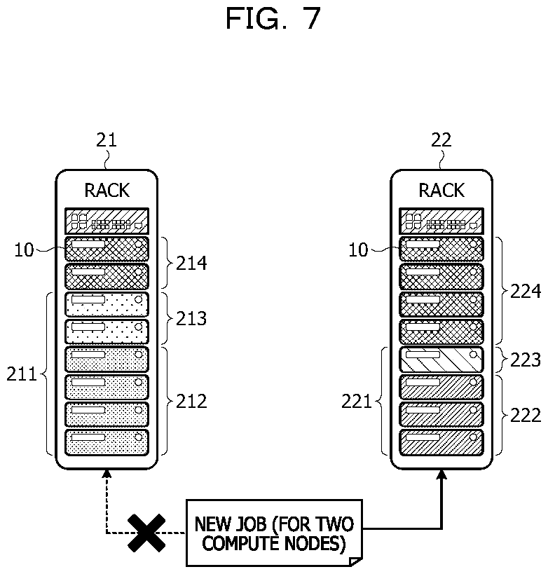

FIG. 7 is a diagram illustrating an outline of processing for determining a deployment destination compute node. For example, as illustrated in FIG. 7, a case will be described where there are the racks 21 and 22 on which eight compute nodes 10 are mounted. Here, a case will be described where a new job sets resource amounts of two compute nodes 10 as a requested resource amount.

In the rack 21, six compute nodes 10 in a range 211 are secured by an existing job. Then, the existing job uses four compute nodes 10 in a range 212, and two compute nodes 10 in a range 213 are excluded from job execution by scale-in.

On the other hand, in the rack 22, four compute nodes 10 in a range 221 are secured by an existing job. Then, the existing job uses three compute nodes 10 in a range 222, and one compute node 10 in the range 223 is excluded from job execution by scale-in. We assume that the existing job executed by the three compute nodes 10 in the range 222 will be completed shortly.

In this state, a free resource amount of each of the racks 21 and 22 is equal to or more than the requested resource amount, and a new job can be deployed. However, in the rack 21, where two compute nodes 10 are excluded by scale-in, there is a high possibility that these compute nodes 10 return to execution of the existing job. In this case, a free resource amount is largely decreased. On the other hand, in the rack 22, one compute node 10 is excluded by scale-in. Even if the compute node 10 returns to execution of the existing job, the decrease in the free resource amount is small. Moreover, in the rack 22, the execution of the existing job will be immediately completed, and this generates a free space.

In this case, when the new job is deployed in the compute node 10 of the rack 21, a resource amount of the entire rack 21 can be used up to the upper limit. However, in a case where the existing job or the new job performs scale-out, a possibility that a part of the job is deployed in another rack 20 is high, and a score is calculated to be high. Therefore, in a case of FIG. 7, in the cluster system 100, the new job is deployed in the compute nodes 10 mounted on the rack 22.

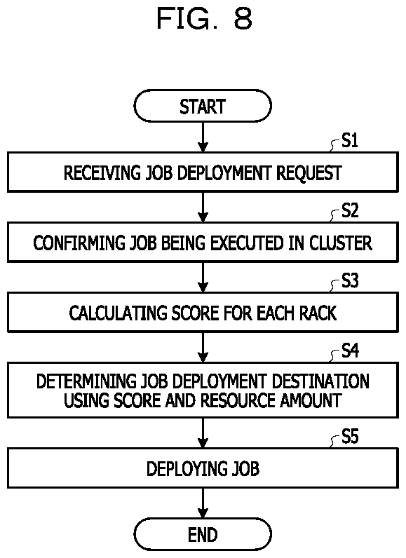

FIG. 8 is a flowchart of job deployment processing by a cluster system according to the first embodiment. Next, a flow of job deployment processing by the cluster system 1 according to the first embodiment will be described with reference to FIG. 8.

The queue 111 receives a job deployment request from the client device 200 and stores the job deployment request (operation S1).

The job management unit 114 confirms a job being executed by the compute node 10 mounted on each rack 20 in the cluster system 1 (operation S2).

The job management unit 114 notifies the job deployment destination determination unit 113 of an execution status of each job. The job deployment destination determination unit 113 calculates a score for each rack 20 using information obtained from the execution status of each job acquired from the job deployment destination determination unit 113 in the formula (1) (operation S3).

Next, the job deployment destination determination unit 113 calculates a resource amount in use in each rack 20 from the execution status of each job. Furthermore, the job deployment destination determination unit 113 acquires information regarding a new job from the queue 111 and obtains a requested resource amount. Then, the job deployment destination determination unit 113 determines a rack 20 to be a job deployment destination and a compute node 10 to be a deployment destination among compute nodes 10 mounted on the rack 20 using the score, the resource amount in use, and the requested resource amount (operation S4).

Next, the job deployment destination determination unit 113 notifies the job deployment unit 112 of information regarding the compute node 10 determined as the deployment destination. The job deployment destination determination unit 113 deploys a job in the compute node 10 designated by the job deployment destination determination unit 113 as a deployment destination (operation S5).

As described above, the cluster system according to the present embodiment determines a rack where a new job is deployed, based on resource usage statuses of the respective racks and a possibility that a part of the new job is deployed in another rack and deploys the new job in a compute node mounted on the rack. As a result, a probability of securing a compute node group having a short communication distance is improved at the time of input of a new job. Furthermore, in a case where the job being executed performs scale-out, a probability that an additional process is deployed at a position with a short communication distance to the secured node group is improved. Therefore, the compute node group that executes the job has a positional relationship with a short communication distance, and the number of communication hops can be reduced. Therefore, it is possible to reduce the communication cost.

Furthermore, in the above description, the rack is used as a group of the compute nodes 10 having a positional relationship in which the compute nodes 10 have a short communication distance. However, it is possible to use another section in a system as long as a communication distance between the belonging compute nodes 10 is short. For example, in the system in which a plurality of compute nodes 10 is connected to each other, the compute nodes 10 can be classified into groups in which communication between belonging compute nodes 10 is within a predetermined number of hops at the maximum, and the group can be treated similarly to the rack in the first embodiment. As a result, a probability of securing a compute node group having a short communication distance is improved at the time of inputting a new job into the system.

[Modification]

In the first embodiment, the Best-Fit is used as the algorithm for solving the bin packing problem. However, by solving the bin packing problem using another algorithm other than this, a rack 20 to be a job deployment destination can be determined.

For example, the algorithm for solving the bin packing problem includes a First-Fit method for selecting a box with the smallest subscript among boxes in which items can be loaded and a Worst-Fit method for selecting a box with the maximum free space among boxes in which items can be loaded. In a case where the Worst-Fit is used, processing is as follows.

In this case, the job deployment destination determination unit 113 calculates fi that is an arrangement possibility index of each rack 20 using the following formula (3). Here, ri+ρ represents a resource usage amount of each rack 20 after the new job is added.

$${f}_{i} = {r}_{i} + ρ + {λs}_{i} \qquad ( 3 )$$

$${r}_{i} + ρ \leq 1$$

Then, the job deployment destination determination unit 113 determines a rack 20 with the smallest fi as a new job deployment destination. In this case, broadly speaking, the job deployment destination determination unit 113 preferentially selects the rack 20 with the smallest ri+ρ. Note that, depending on the value of λsi, the job deployment destination determination unit 113 may select a rack 20 other than the rack 20 with the smallest ri+ρ.

As described above, even if the algorithm other than the Best-Fit is used as the algorithm for solving the bin packing problem, the deployment destination rack can be determined so that the compute node group that executes the job has a close positional relationship. Therefore, the communication cost can be reduced.

### Second Embodiment

Next, a second embodiment will be described. A cluster system according to the present embodiment is illustrated in the block diagram in FIG. 3. A cluster system 1 according to the present embodiment determines a job deployment destination in a case where a plurality of jobs shares the same compute node 10. In the following description, description of a function of each unit similar to that in the first embodiment will be omitted.

A job deployment destination determination unit 113 acquires a resource requirement condition of each job for operating in the cluster system 1 from an execution status of each job acquired from a job management unit 114. The resource requirement condition is information indicating which one of a node-occupying job that occupies the compute node 10 where the job is deployed and does not allow the compute node 10 to be shared with another job or a node-sharing job that allows to share the compute node 10 where the job is deployed with another job.

Then, the job deployment destination determination unit 113 sets a free resource to zero for the compute node 10 where the node-occupying job is deployed. Furthermore, for the compute node 10 where the node-sharing job is deployed, the job deployment destination determination unit 113 calculates a free space of the compute node 10 by subtracting a resource amount used for the job.

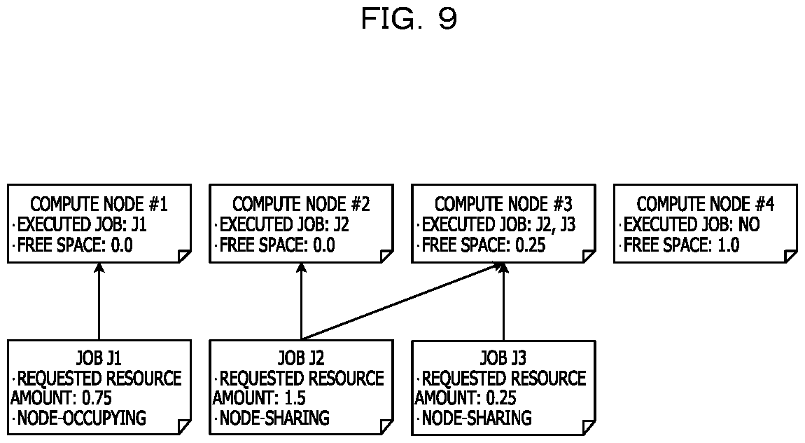

FIG. 9 is a diagram for explaining free space calculation according to the second embodiment. Here, an example of a state will be described where compute nodes #1 to #4 are mounted on a rack 20 as compute nodes 10 and jobs J1 to J3 are deployed therein. A requested resource amount of the job J1 in a case where a total resource amount of each compute node 10 is set to one is 0.75. Moreover, the job J1 is a node-occupying job. Furthermore, a requested resource amount of the job J2 is 1.5. Moreover, the job J2 is a node-sharing job. Furthermore, a requested resource amount of the job J3 is 0.25. Moreover, the job J3 is a node-sharing job.

In this case, although the job J1 is deployed in the compute node #1, and a resource of 0.25 is actually left, the job J1 is a node-occupying job. Therefore, the job deployment destination determination unit 113 sets a free space of the compute node #1 to zero. Furthermore, the job J2 is deployed in the compute nodes #2 and #3, and all the resource amount of the compute node #2 is used by the job J2. Therefore, the job deployment destination determination unit 113 sets a free space of the compute node #2 to zero. On the other hand, the job J3 is also deployed in the compute node #3, and the job deployment destination determination unit 113 sets 0.25 that is a value obtained by subtracting a remaining requested resource amount of the job J2 and a requested resource amount of the job J3 from the entire resource amount as a free space of the compute node #3. Then, because both of the jobs J2 and J3 are node-sharing jobs, the job deployment destination determination unit 113 sets the free space of the compute node #3 to 0.25. Furthermore, regarding a compute node 10 such as a compute node #4 where a job is not deployed, the job deployment destination determination unit 113 sets a free space to one.

Next, the job deployment destination determination unit 113 calculates a value obtained by subtracting a resource amount in use from the entire resource amount of each rack 20 using the free space of each compute node 10. Then, the job deployment destination determination unit 113 calculates fi that is an arrangement possibility index of each rack 20 using the formula (2).

Then, the job deployment destination determination unit 113 determines a rack 20 with the smallest fi as a deployment destination rack 20. Next, the job deployment destination determination unit 113 treats the plurality of compute nodes 10 mounted on the deployment destination rack 20 as a bin packing problem for packing a new job in each compute node 10 having the calculated free space and determines a compute node 10 that is a new job deployment destination.

As described above, the cluster system according to the present embodiment calculates a free space of each compute node, based on a resource requirement condition of each job and determines a deployment destination rack and compute nodes using the calculated free space. As a result, even in a case where the jobs share the node, a probability that a compute node group having a close relationship is secured at the time of input of a new job is improved, and the number of communication hops can be reduced. Therefore, communication cost can be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer including a plurality of compute nodes that executes a job and is communicable with each other, the computer comprising:
a memory; and
a processor coupled to the memory and configured to:
acquire a new job and store the new job in the memory;
acquire information regarding an execution state of existing jobs run on the compute nodes for each group of the compute nodes that have a short communication distance;
when the new job is deployed in the compute nodes that belong to the group, based on the acquired information regarding the execution state,
obtain, for each group, a probability in which the existing jobs or a part of the new job is deployed in the compute nodes that belong to a group different from a deployment destination group in which the new job is deployed;
determine a group in which the new job is deployed, based on the obtained probability and a usage amount of the compute nodes for each group by the existing jobs; and
acquire the stored new job, and deploy the new job in the compute nodes, based on the determination of the group in which the new job is to be deployed.

2. The computer according to claim 1, wherein
the processor determines a group where the new job is deployed by solving a bin packing problem in which the job is packed for each of the compute nodes that belong to each group.

3. The computer according to claim 1, wherein
the information regarding the execution state of the existing jobs includes information used to obtain the usage amount of the existing jobs of the compute nodes for each group and information that indicates a possibility of a fluctuation in the usage amount.

4. The computer according to claim 1, wherein
when a compute node of the plurality of computer nodes executes a plurality of jobs,
the processor
acquires the usage amount of each compute node by the existing jobs and a requirement condition for use of the compute node of each existing jobs,
determines a group in which the new job is deployed, based on the usage amount of each compute node by the existing jobs and the requirement condition, and
determines the compute node in which the new job is deployed from among the compute nodes that belong to a group in which the new job is deployed.

5. The computer according to claim 1, wherein
a group of the compute nodes of which a predetermined number of hops is the maximum number of hops is set as the group.

6. A job scheduling method that causes a computer to execute a process, the computer including a plurality of compute nodes that executes a job and is communicable with each other, the process comprising:
acquiring storing a new job and storing the new job in a memory;
acquiring information regarding an execution state of existing jobs run on the compute nodes for each group of the compute nodes that have a short communication distance;
when the new job is deployed in the compute nodes that belong to the group, based on the acquired information regarding the execution state,
obtaining, for each group, a probability in which the existing jobs or a part of the new job is deployed in the compute nodes that belongs to a group different from a deployment destination group in which the new job is deployed;
determining a group in which the new job is deployed, based on the obtained probability and a usage amount of the compute nodes for each group by the existing jobs; and
acquiring the stored new job, and deploy the new job in the compute nodes, based on the determination of the group in which the new job is to be deployed.
